(19) United States
(12) Patent Application Publication
(10) Pub. No.: US 2019/0023480 A1
(43) Pub. Date: Jan. 24, 2019

(54) Foldable Cushion Bag

(71) Applicant: Chih-Hung Lin, Taichung City (TW)

(72) Inventor: Chih-Hung Lin, Taichung City (TW)

(21) Appl. No.: 15/654,822

(22) Filed: Jul. 20, 2017

(51) Int. Cl. B65D 81/38; B65D 81/34; B65D 30/08; B29C 65/00

(52) U.S. Cl. CPC B65D 81/3888; B65D 81/34; B29C 66/723; B29C 66/436; B65D 31/02

(57) ABSTRACT

A foldable cushion bag includes a main body and a handling unit. The main body includes a bottom wall and a sleeve wall jointed to the bottom wall. The bottom wall and the sleeve wall form a first heat sealed joint therebetween and cooperatively define a space for receiving a bottle. Each of the bottom and sleeve walls includes a multilayered structure having an outermost protecting layer, a first adhesive layer, a heat sealing layer, a second adhesive layer and an innermost cushion layer in that order. The handling unit is connected to the sleeve wall and opposite to the bottom wall. The handling unit is formed with a gripping hole.

### FIELD

The disclosure relates to a foldable bag, and more particularly to a foldable cushion bag including a multilayered structure.

### BACKGROUND

Referring to FIG. 1, a conventional wrapping material for a bottle 9, such as a glass bottle, is box-shaped and includes a main body 11 that is formed with a space for receiving the bottle 9, and two position members 12 that are respectively disposed in and abut against upper and lower portions of the main body 11 and intimately sleeve on a neck portion and a bottom portion of the bottle 9, respectively. The position members 12 are used for holding the bottle 9 in position and attenuate an accidental impact on the bottle 9.

However, the conventional wrapping material for the bottle 9 is disadvantageous in the following aspects:

First, the main body 11 and the position members 12 are usually made of paper and are easily dampened and non-durable. In addition, the position members 12 have to be folded into a predetermined shape before use and are inconvenient to use.

Second, since the position members 12 only surround the neck and bottom portions of the bottle, a body portion 91 connected therebetween and formed with a major receiving space is free of support of the position members 12. Hence, the body portion 91 is likely to crack upon the accidental impact. Although it may be proposed to increase the number of the position members 12 for supporting the body portion 91 of the bottle 9, in doing so, it is apparent that the production cost and the inconvenience in use will also unavoidably increase.

Third, the paper wrapping material, which includes the box-shaped main body 11 and the position members 12, takes up too much space and is non-durable.

### SUMMARY

Therefore, an object of the disclosure is to provide a foldable cushion bag that can alleviate at least one of the drawbacks of the prior art.

A foldable cushion bag includes a main body and a handling unit.

The main body includes a bottom wall and a sleeve wall jointed to the bottom wall. The bottom wall and the sleeve wall form a first heat sealed joint therebetween and cooperatively define a space for receiving a bottle. Each of the bottom and sleeve walls includes a multilayered structure having an outermost protecting layer, a first adhesive layer, a heat sealing layer, a second adhesive layer and an innermost cushion layer in that order. The innermost cushion layer of each of the bottom and sleeve walls is immediately proximate to the space.

The handling unit is connected to the sleeve wall and opposite to the bottom wall. The handling unit is formed with a gripping hole.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of a conventional bag for receiving a bottle;

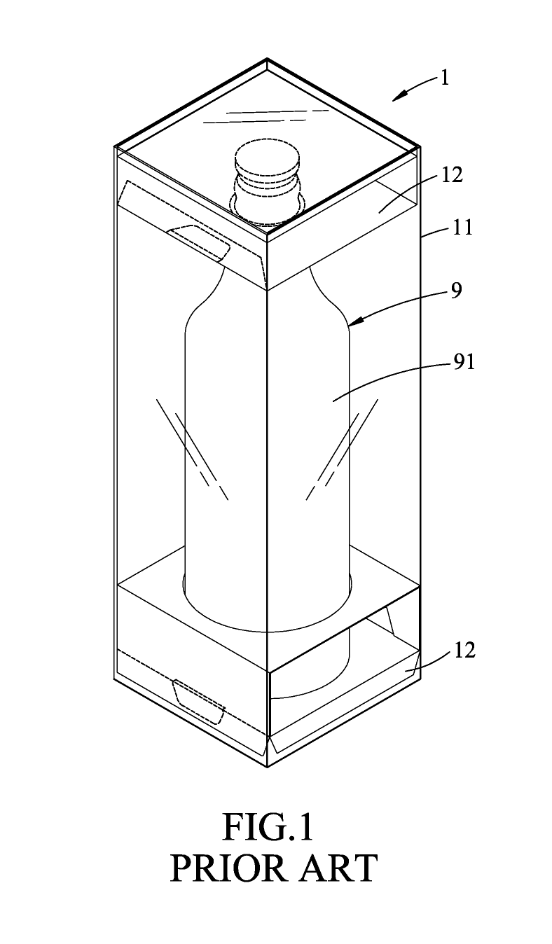

FIG. 2 is a perspective view of an embodiment of the foldable cushion bag according to the disclosure;

FIG. 3 is a cross-sectional view taken along line III-III of FIG. 2;

FIG. 4 is a fragmentary schematic view illustrating a multilayered structure of a main body of the foldable cushion bag of the embodiment;

FIG. 5 is a schematic view illustrating the embodiment of the foldable cushion bag used for receiving a bottle;

FIG. 6 is a perspective view of another configuration of the embodiment of the foldable cushion bag according to the disclosure; and

FIG. 7 is a perspective view of yet another configuration of the embodiment of the foldable cushion bag according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

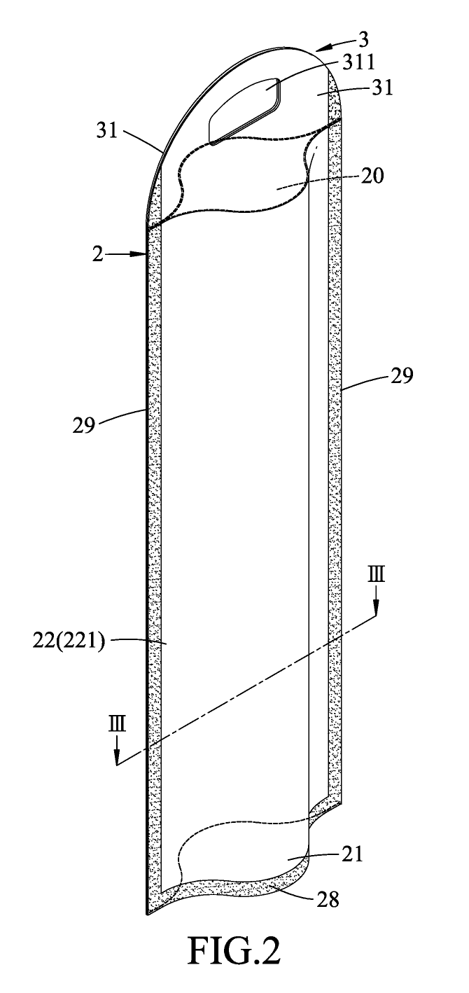

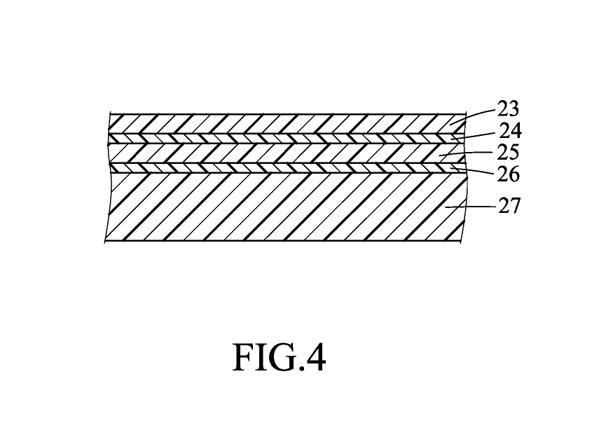

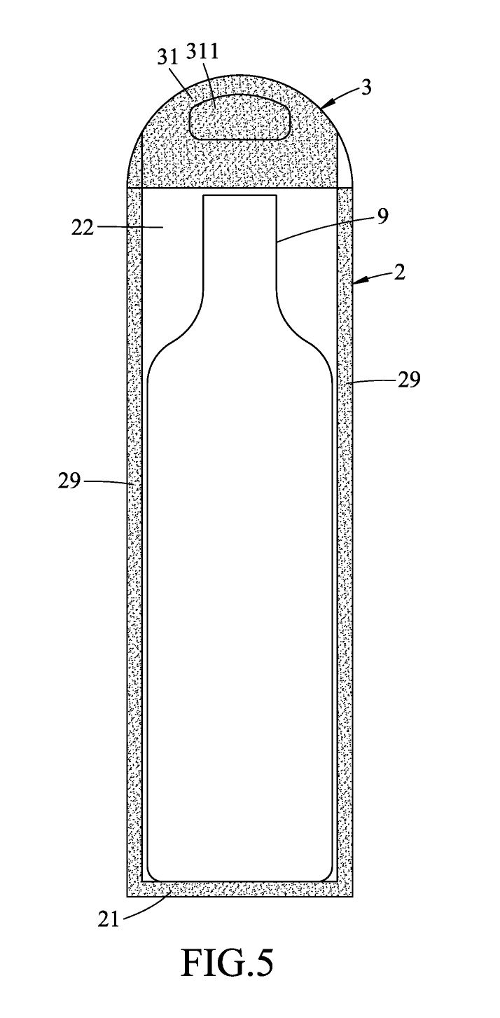

Referring to FIGS. 2 to 5, an embodiment of a foldable cushion bag used for receiving a bottle 9 includes a main body 2 and a handling unit 3.

The main body 2 includes a bottom wall 21 and a sleeve wall 22 that is joined to the bottom wall 21. The bottom wall 21 and the sleeve wall 22 form a first heat sealed joint therebetween and cooperatively define a space 20 for receiving the bottle 9.

Each of the bottom wall 21 and the sleeve wall 22 includes a multilayered structure that has an outermost protecting layer 23, a first adhesive layer 24, a heat sealing layer 25, a second adhesive layer 26 and an innermost cushion layer 27 in that order. The innermost cushion layer 27 is immediately proximate to the space 20.

The outermost protecting layer 23 of the multilayered structure is made from a flexible material that is selected from plastics, fabrics, paper or combinations thereof.

More specifically, the outermost protecting layer 23 of the multilayered structure is a plastic film and made from plastic selected from the group consisting of polyethylene terephthalate, polyethylene, polypropylene, nylon and combinations thereof. Thus, a support capability of the foldable cushion bag can be improved. The outermost protecting layer 23 may be made from biaxially oriented polypropylene (BOPP) in practice.

In one form, the outermost protecting layer 23 of the multilayered structure maybe made from the fabrics that are selected from woven fabrics and nonwoven fabrics. The nonwoven fabrics may be selected from plant fibers (e.g. cotton) and synthetic fibers made from polypropylene, polyvinyl chloride (PVC), polyethylene, ethylene-vinyl acetate copolymers (EVA) or polyvinyl alcohol (PVA).

The first adhesive layer 24 of the multilayered structure may be connected between the outermost protecting layer 23 and the heat sealing layer 25 using laminating techniques, such as dry laminating techniques or solvent-less laminating techniques. The first adhesive layer 24 may be made from low density polyethylene (LDPE). The heat sealing layer 25 of the multilayered structure may be made from polyolefin. More specifically, the polyolefin is selected from the group consisting of polyethylene, polypropylene and combinations thereof. The second adhesive layer 26 of the multilayered structure maybe connected between the heat sealing layer 25 and the innermost cushion layer 27 using the laminating techniques, such as the dry laminating techniques or the solvent-less laminating techniques. The second adhesive layer 26 may be made from LDPE.

The innermost cushion layer 27 of the multilayered structure is a foamed plastic. The foamed plastic is selected from the group consisting of foamed polyethylene, foamed polystyrene, foamed ethylene-vinyl acetate copolymers, foamed polypropylene, foamed ethylene copolymers and combinations thereof. The innermost cushion layer 27 has a thickness based on a cushion requirement in actual practice. The thickness may be as thin as about 1 mm, or greater than or equal to 10 mm according to manufacturing ability of current manufacturing machines.

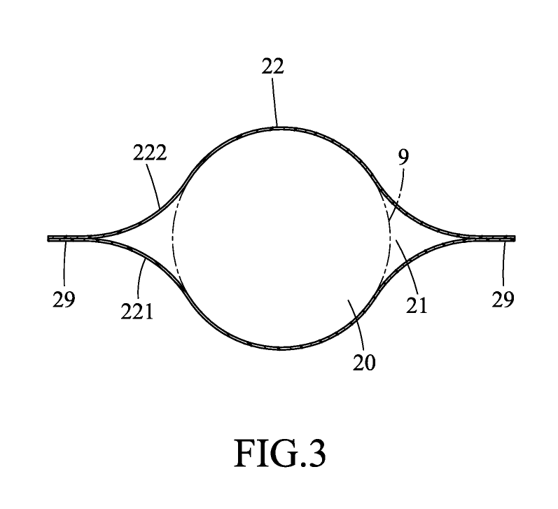

Referring back to FIG. 3, the first heat sealed joint is free of the second adhesive layer 26 and the innermost cushion layer 27.

More specifically, the sleeve wall 22 is a multi-part wall and has two second heat sealed joints. The second heat sealed joints are free of the second adhesive layer 26 and the innermost cushion layer 27. In the embodiment, the main body 21 includes a front wall portion 221 and a rear wall portion 222. The first heat sealed joint is disposed at bottoms of the front and rear wall portions 221, 222 and at an outer periphery of the bottom wall 21. Each of the two second heat sealed joints is disposed between one of two opposite sides of the front wall portion 221 and one of two opposite sides of the real wall portion 222. The bottom wall 21 and the front and rear wall portions 221, 222 cooperatively define the space 20.

The handling unit 3 is connected to the sleeve wall 22 of the main body 2 and opposite to the bottom wall 21. The handling unit 3 is formed with a gripping hole 311. In the embodiment, the handling unit 3 includes a pair of grip portions 31. Each of the grip portions 31 has the gripping hole 311 and is formed as one piece with one of the front and rear wall portions 221, 222 oppositely to the bottom wall 21.

A conventional manufacturing machine for making a multilayered structure composed of a protecting layer, an adhesive layer and a heat sealing layer is applicable to make the multilayered structure of the embodiment which includes the outermost protecting layer 23, the first adhesive layer 24, the heat sealing layer 25, the second adhesive layer 26 and the innermost cushion layer 27 after suitable adjustments are made. Therefore, it is not necessary to obtain a new type of manufacturing machine for making the multilayered structure of the foldable cushion bag of this disclosure. In addition, the outermost protecting layer 23 may be printed with a pattern (not shown) with printing ink to provide the foldable cushion bag with an appealing appearance or a suitable advertisement so as to be widely applicable to any bottle-shaped products.

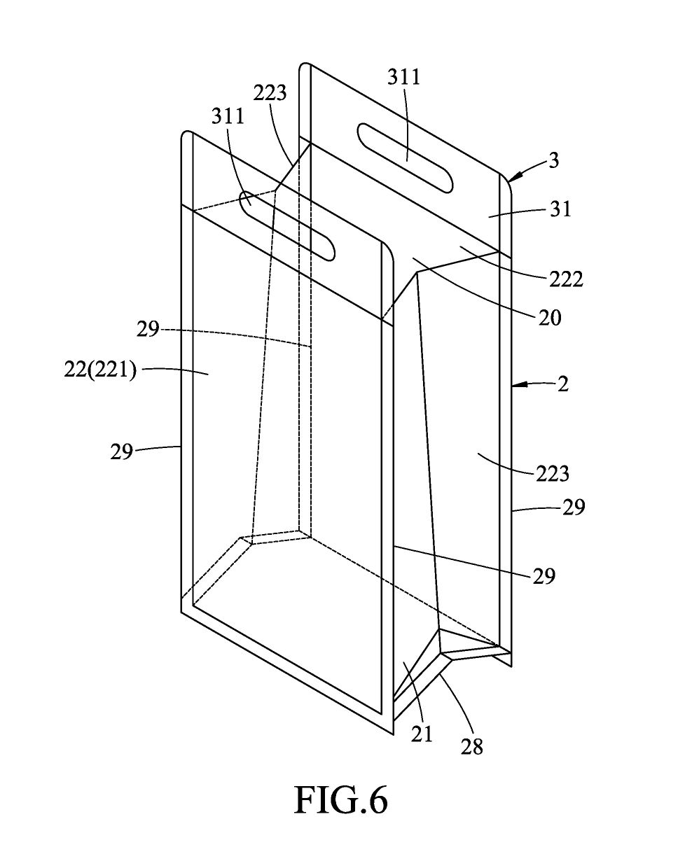

Referring to FIG. 6, another configuration of the embodiment of the foldable cushion bag according to the disclosure is illustrated.

The sleeve wall 22 of the main body 2 further includes two opposite side wall portions 223 in addition to the front wall portion 221 and the rear wall portion 222. The two opposite side wall portions 223 interconnect the front and rear wall portions 221, 222. The front and rear wall portions 221, 222 and two opposite side wall portions 223 cooperatively define the space 20 for receiving a bottle-shaped article that may have a body with a square cross section. In this configuration, the two opposite side wall portions 223, the front wall portion 221 and the rear wall portion 222 of the sleeve wall 22 form four of the second heat sealed corner joints 29, each of which is disposed between one of two opposite sides of one of the front and rear wall portions 221, 222 and one of two opposite sides of one of the side wall portions 223. The first heat sealed joint is disposed at bottoms of the front, rear and side wall portions 221, 222, 223 and at an outer periphery of the bottom wall 21.

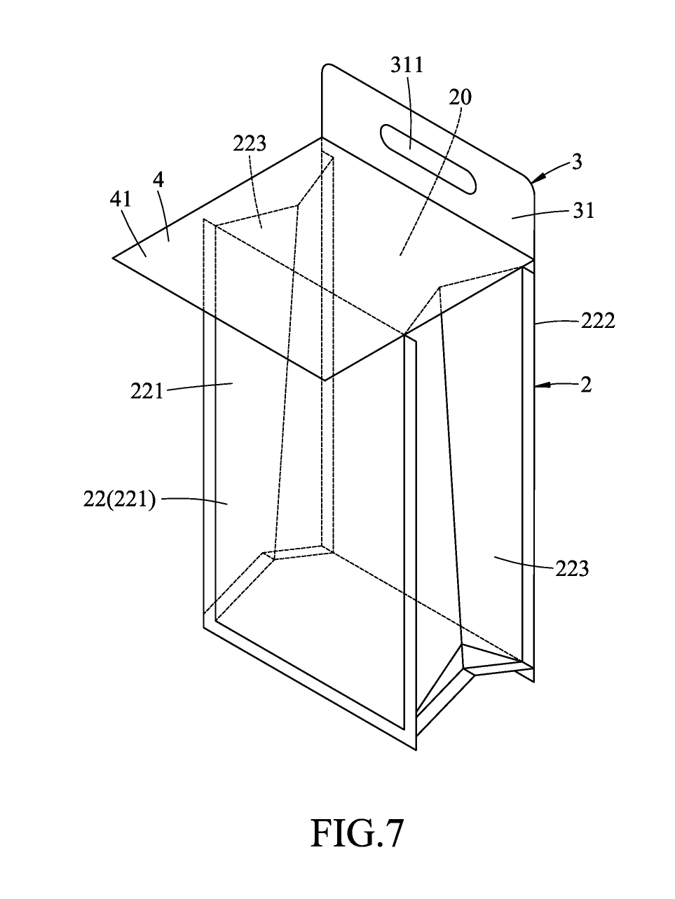

Referring to FIG. 7, yet another configuration of the embodiment of the foldable cushion bag according to the disclosure is illustrated.

The handling unit 3 includes one of the grip portion 31 that is formed as one piece with one of the front and rear wall portions 221, 222 of the sleeve wall 22.

The foldable cushion bag further includes a closing panel 4 that projects from a portion between the gripping hole 311 of the grip portion 31 of the handling unit 3 and the one of the front and rear wall portions 211, 222 of the sleeve wall 22 toward the other one of the front and rear wall portions 221, 222. The closing panel 4 extends over the side wall portions 223 and is beyond the other one of the front and rear wall portions 221, 222 and has one end abuttable with an outer surface of the other one of the front and rear portions 221, 222.

In the embodiment, the closing panel 4 includes a multilayered structure. The multilayered structure includes an outermost protecting layer, a first adhesive layer, and a heat sealing layer in that order. The heat sealing layer is immediately proximate to the space. The outermost protecting layer may be made from a material selected from the group consisting of BOPP, polyethylene terephthalate, and combinations thereof. For the multilayered structure of the closing panel 4, the first adhesive layer may be connected between the outermost protecting layer and the heat sealing layer using the laminating techniques, such as the dry laminating techniques or the solvent-less laminating techniques, the first adhesive layer may be made from LDPE, and the heat sealing layer of the multilayered structure may be made from polyolefin.

Based on the abovementioned structural design of the foldable cushion bag, the foldable cushion bag of the disclosure may be relatively small in size for ease of storage or transportation. The weight and the production cost of the foldable cushion bag can be reduced and the foldable cushion bag is reusable and durable. Moreover, since the innermost cushion layer 27 of the bottom wall 21 and the sleeve wall 22 and the heat sealing layer of the closing panel 4 are immediately proximate to the space 20, a contacting area between the main body 21 and the bottle 9 is relatively great, thereby improving the cushion capability of the foldable cushion bag. Furthermore, the printed pattern may be printed on the outermost protecting layer 27 for elevating aesthetic and advertising effects of the foldable cushion bag. Formation of the handling unit 3 increases portability of the foldable cushion bag.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A foldable cushion bag, comprising:
a main body including a bottom wall and a sleeve wall that is jointed to said bottom wall, said bottom wall and said sleeve wall forming a first heat sealed joint therebetween and cooperatively defining a space for receiving a bottle, each of said bottom wall and said sleeve wall including a multilayered structure that has an outermost protecting layer, a first adhesive layer, a heat sealing layer, a second adhesive layer and an innermost cushion layer in that order, said innermost cushion layer being immediately proximate to said space; and
a handling unit connected to said sleeve wall of said main body and opposite to said bottom wall, said handling unit being formed with a gripping hole.

2. The foldable cushion bag as claimed in claim 1, wherein said first heat sealed joint is free of said second adhesive layer and said innermost cushion layer.

3. The foldable cushion bag as claimed in claim 1, wherein said sleeve wall is a multi-part wall and has at least two second heat sealed joints which are free of said second adhesive layer and said innermost cushion layer.

4. The foldable cushion bag as claimed in claim 1, wherein said outermost protecting layer is made from a flexible material selected from plastics, fabrics and paper, said heat sealing layer being made from polyolefin, said cushion layer being a foamed plastic.

5. The foldable cushion bag of claim 1, wherein said outermost protecting layer is a plastic film.

6. The foldable cushion bag of claim 1, wherein said outermost protecting layer is made from a plastic selected from the group consisting of polyethylene terephthalate, polyethylene, polypropylene, nylon and combinations thereof.

7. The foldable cushion bag of claim 4, wherein the polyolefin is selected from the group consisting of polyethylene, polypropylene and combinations thereof.

8. The foldable cushion bag of claim 4, wherein said foamed plastic is selected from the group consisting of polyethylene, polystyrene, ethylene-vinyl acetate copolymers, polypropylene, ethylene copolymers and combinations thereof.

9. The foldable cushion bag of claim 4, wherein said fabrics are selected from woven fabrics and nonwoven fabrics.

10. The foldable cushion bag of claim 3, wherein said sleeve wall includes a front wall portion, and a rear wall portion, each of said at least two second heat sealed joints being disposed between one of two opposite sides of said front wall portion and one of two opposite sides of said rear wall portion.

11. The foldable cushion bag of claim 10, wherein said first heat sealed joint is disposed at bottoms of said front and rear wall portions and at an outer periphery of said bottom wall.

12. The foldable cushion bag of claim 10, wherein said handling unit includes a pair of grip portions, each of which is formed as one piece with one of said front and rear wall portions oppositely of said bottom wall, and each of which has said gripping hole 311.

13. The foldable cushion bag of claim 3, wherein said sleeve wall includes a front wall portion, a rear wall portion, and two opposite side wall portions which interconnect said front and rear wall portions, said at least two second heat sealed joints including four heat sealed corner joints, each of which is disposed between one of two opposite sides of one of said front and rear wall portions and one of two opposite sides of one of said side wall portions, said first heat sealed joint being disposed at bottoms of said front, rear and side wall portions and at an outer periphery of said bottom wall.

14. The foldable cushion bag of claim 13, wherein said handling unit includes a pair of grip portions, each of which is formed as one piece with one of said front and rear portions of the sleeve wall oppositely of said bottom wall and has said gripping hole.

15. The foldable cushion bag of claim 13, wherein said handling unit includes a grip portion formed as one piece with one of said front and rear wall portions of the sleeve wall and formed with said gripping hole, and wherein the foldable cushion bag further comprises a closing panel projecting from a position between said grip hole of said handling portion and said one of said front and rear portions toward the other one of said front and rear wall portions, said closing panel extending over said side wall portions and beyond the other one of said front and rear wall portions and having one end abuttable with an outer surface of the other one of said front and rear portions.
